(19) United States
(12) Patent Application Publication
(10) Pub. No.: US 2008/0178290 A1
(43) Pub. Date: Jul. 24, 2008

(54) Method of secure data processing on a computer system

(75) Inventors: Matthias Besch, Munchen (DE); Heiko Bihr, Oberhausen (DE); Andreas Hellrung, Essen (DE)

Correspondence Address: K.F. ROSS P.C., 5683 RIVERDALE AVENUE, SUITE 203 BOX 900, BRONX, NY, 10471-0900, US

(73) Assignee: SECURITY NETWORKS Aktiengesellschaft

(21) Appl. No.: 12/001,471

(22) Filed: Dec. 11, 2007

(30) Foreign Application Priority Data
Dec. 12, 2006 (EP) 06025684.9

(51) Int. Cl. G06F 11/00

(52) U.S. Cl. 726/22

(57) ABSTRACT

Secure data processing is carried out on a computer system with a higher-level or coordinated secure operating system that is not visible for a user. The secure operating system as a computer program application provides a virtual machine with virtual computer hardware on which a user operating system visible and usable for the user can be executed and which has at least one virtual mass memory with a file system of the user operating system or the secure operating system is encapsulated in a first virtual machine and the user operating system visible and usable for the user and equipped with at least one virtual mass memory with a file system is executed in a second virtual machine. The secure operating system cannot by manipulated by the user or a computer program application, in particular a harmful file.

### FIELD OF THE INVENTION

The present invention relates to data processing. More particularly this invention concerns the secure processing of data on a computer system.

### BACKGROUND OF THE INVENTION

Computer systems operated with the known user operating systems are being increasingly attacked by malware. Such malware as computer viruses, worms and trojans usually reside unnoticed by the user in the operating system and manipulate it. Depending on the type of malware, for example, secret data can be spied out and files destroyed. The malware can enter the computer system by email, downloading data or external mass storage devices such as, for example, a USB stick. The malware generates additional files on the attacked computer or attaches as additional program codes to already existing files. When such a modified file is retrieved, the malware becomes active and can reproduce, for example, by damaging further files.

Antivirus programs are installed on the computer systems as countermeasures. However, this protective software can be switched off by technically experienced users, and even by the malware itself and can be manipulated and bypassed so that the computer is exposed to attacks by or via the malware without protection.

From practice it is known to provide a virtual machine on a higher-level operating system on which a user operating system is executed as a computer program application. While the higher-level operating system can be protected by virtue of the user operating system not being able to access protected memory areas, the protection of the user operating system itself by conventional antivirus programs is still inadequate.

In addition, it is known from U.S. Pat. No. 6,067,410 to insert a virtual machine for repairing a virus-infected computer file as an encapsulated computer program application inside a user operating system. The virus-infected computer file is executed on the virtual machine and the virus thereby activated. By activating the virus without risk for the user operating system, the virus can be decrypted and subsequently removed from the host file.

### OBJECTS OF THE INVENTION

It is therefore an object of the present invention to provide an improved method of secure data processing on a computer system.

Another object is the provision of such an improved method of secure data processing on a computer system that overcomes the above-given disadvantages, in particular that enhances the security against attack by malware during data processing on a computer system with a user operating system.

### SUMMARY OF THE INVENTION

The object is attained according to the invention by a method of secure data processing on a computer system with a higher-level or coordinated secure operating system that is not visible to a user. According to the invention the secure operating system as a computer program application provides a virtual machine (VM) with virtual computer hardware on which a user operating system visible to and usable by the user can be executed and that has at least one virtual mass memory with a file system of the user operating system or the secure operating system is encapsulated in a first virtual machine and the user operating system visible to and usable by the user and equipped with at least one virtual mass memory with a file system is executed in a second virtual machine. This secure operating system cannot by manipulated by the user or a computer program application, in particular malware. Then the file system of the user operating system is read in and provided to an analysis process executed on the secure operating system. Subsequently a read access of the user operating system to a data block in the virtual mass memory is intercepted and transferred to the analysis process that assigns the data block to a file and determines all the data blocks pertaining to the file. Finally the analysis process controls a test process executed in the secure operating system (scan engine) to detect harmful files.

Here and subsequently, harmful files means malware and/or a file modified by malware and/or a file generated by malware. With regard to the embodiment with the second virtual machine, the invention assumes that new technologies allow the secure operating system including the antivirus service itself to be externalized into a second virtual machine and from there to access the virtual hard disk of the user operating system in the first virtual machine.

According to the invention, the analysis process and the test process as components of an antivirus system are externalized from the user operating system into a non-visible and non-accessible secure operating system (security shell) separate from the user operating system. The user operating systems can be operated as usual. The selection of the user operating system and the secure operating system is not restricted within the scope of the invention. The Windows® operating systems common throughout the world and usually familiar to users, for example, are suitable as the user operating system, where the method according to the invention ensures a very high degree of security against manipulations by means of the security devices implemented in the user operating systems for protection against malware or harmful files. When starting up the system, the security shell is started before the user operating system and then the user operating system is started as usual where, however, according to the invention the analysis process, the test process and other optionally provided security serves are executed hidden and tamper-proof in the secure operating system. By executing the user operating system on a virtual machine, the maintenance of a plurality of user operating systems in a typically heterogeneous infrastructure is additionally homogenized and significantly simplified. A Unix or Linux operating systems is particularly suitable as the secure operating system since these can be configured according to the respective requirements, have few weak points from the security technology point of view and can be well minimized and hardened against possible attacks from malware.

The method according to the invention for secure data processing is typically a component of a comprehensive security environment implemented on the secure operating system. Other services of the security environment can, for example, be hard disk encryption, back-up of the virtual hard disk, access restriction for example, for USB equipment and restriction of network communication from and to the user operating system that can also proceed protected from manipulation in the secure operating system. The configuration of these services in connection with the method according to the invention is typically effected via a central management system.

Within the scope of a preferred embodiment of the method according to the invention, it is provided that a data structure is created that links the sectors of the virtual mass memory with the files located therein, so that efficient assignment can be made in the sector direction to all file blocks of a file. In addition, a state variable is provided for each file. By linking the files to an allocated state variable, one can avoid that during a read access of the user operating system to a data block in the virtual mass memory, the requested file must always be checked for a possible damaged state. With the aid of the data structure, files in the virtual mass memory that have been checked by the test process to detect harmful files and have been identified as harmless are provided with a first state variable “clean” and files that have not yet been checked or that have been modified by the user operating system are provided with a second state variable “dirty.” If the analysis process determines an access to a file of the virtual mass memory provided with the state variable “clean,” this can be provided to the user operating system without renewed testing so that a significantly increased data throughput can be achieved compared to an undifferentiated examination of all the requested files. Since only files provided with the state variable “dirty” need be checked by the test process (scan engine) for a possible damaged state, the efficiency of the method according to the invention can be increased in such a manner that only slight time delays barely perceptible to the user occur. Overall, as a result of the high data throughput, synchronization problems between the user operating system and the secure operating system can be largely avoided. It is within the scope of the invention to check data to be read for harmful files during read accesses of the user operating system (on-access scan). Appropriately, examination of data streams for viruses is not provided within the scope of the method according to the invention.

When a file that is identified as a harmful file is located by the test process, there are various treatment options that can be selected depending on the security guidelines of the operator of the computer system. It should be noted here that a harmful, virus-infected file cannot easily be deleted since in this case the view that the user operating system has of the file system does not necessarily agree with the actual data structures provided on the virtual hard disk. Deletion can lead to an incorrect allocation of the data blocks to individual files that can results in faults or in complete crashing of the user operating system. Within the scope of the method according to the invention it is therefore usually provided that harmful files are not deleted but are overwritten and thus made unusable, so that read access of the user operating system to such a file is denied. Within the scope of the present invention, it can also be provided that a harmful file is copied into a secured memory area of the secure operating system so that the attack by the malware can be documented and analyzed. For each write access of the user operating system, the relevant sectors are logged and transferred to the analysis process where the corresponding file is provided with the state variable “dirty.”

In addition to the described monitoring of the read accesses (on-access scan), the virtual hard disk or its image that was created by the secure operating system can be checked for a possible attack by malware (full scan). The virtual hard disk can be generated either during downloading of the user operating system or during operation of the user operating system. A complete examination of the virtual hard disk during operation of the user operating system is disadvantageous since the data structure is continuously subject to change as a result of write accesses and thus synchronization problems can occur. It should be noted here that in the known user operating systems it is usually standard to hold files, in particular system files, for a fairly long time in a cache memory and only write the virtual mass memory at long time intervals.

In an advantageous further development of the method according to the invention it is provided that the virtual hard disk is checked by the test process in the non-active state of the user operating system. It is advantageous here if an image is generated during the downloading of the user operating system since, if no harmful files have been found, when restarting the user operating system it can be assumed with a very high certainty that the virtual mass memory is then free from harmful files. A disadvantage here is that the user operating system cannot be used during checking of the virtual hard disk.

In an alternative further development of the method according to the invention the image of the virtual hard disk is checked by the test process during operation of the user operating system. The image can have been created, for example, during a previous downloading of the user operating system or during operation of the user operating system. The image is then examined during operation of the user operating system without substantial adverse effects, in particular since the examination can take place with a low priority in relation to the processor load of the computer system so that an examination is merely made when sufficient reserve capacity is available. If it is established during the examination that the image is free from harmful files, the entire image can be provided with the state variable “clean.” In particular, it is also possible to hold in readiness an older backup image that, after examination of the actual image, is deleted if this actual image is virus-free and replaced by the actual image. It should be noted here that overall a very large memory requirement is required for the back-up image, the actual image and the virtual mass memory that the user operating system accesses during examination.

If a harmful file is found during examination of the virtual hard disk, an alarm can appropriately be triggered to inform the user of the computer system or an administrator. To eliminate the malware, an older, clean image of the virtual hard disk can be restored, infected files can be deleted or copied into a secured memory area of the secure operating system where the cleaned image is stored as a clean backup. It should be noted here that the removed files are initially not available when the backup is subsequently played back. In addition, the virtual hard disk can also be repaired so that a harmful file on the hard disk or on an image of the virtual hard disk is replaced by a corresponding undamaged file, in particular from an older image or from a reference image. Alternatively, a harmful file on the virtual hard disk or on the image of the virtual hard disk is can be initially made unusable by overwriting, in which case a corresponding undamaged file is subsequently added manually by the user or the administrator.

The invention is based on the discovery that it is effective to remove all central security components from the user operating system (in particular Windows®) and externalize these in a secure operating system protected from manipulation. The decoupling between user and secure operating system is provided by a virtualization layer. This means that the user operating system is placed on a virtual computer instead of on real hardware and is protected and monitored by functions of the secure operating system. The secure operating system itself is appropriately protected by comprehensive measures against non-authorized access. The subject matter of the invention is in particular the so-called “virtual on-access scan.” Instead of the usual desktop virus scanner under Windows®, permanent virus checking is protected from malware and executed invisibly to the end user in the secure operating system. In this case, virtual machine and security components must cooperate efficiently and be synchronized with one another. It is within the scope of the invention that the virus scanner is no longer located as a Windows® application above the NTFS file system but protected as an application of the secure operating system logically between the NTFS file system and the virtual hard disk. In order that the virus scan can nevertheless be carried out efficiently, the virtual machine delivers additional information about affected read sectors of the virtual hard disk. It is also within the scope of the invention to use an intelligent caching method to determine minimal data blocks required to be able to identify a virus infection of a file. In the event of a positive result, various strategies for further dealing with infected files are possible.

### BRIEF DESCRIPTION OF THE DRAWING

The above and other objects, features, and advantages will become more readily apparent from the following description, reference being made to the accompanying drawing in which:

FIG. 1 is a block diagram of the complete architecture of the computer system for carrying out the method according to the invention;

FIG. 2 is another block diagram showing the basic operating mode of the method according to the invention;

FIG. 3 is a diagram illustrating the architecture of the read access monitoring according to the invention; and

FIG. 4 is a block diagram for carrying out the method according to the invention.

### SPECIFIC DESCRIPTION

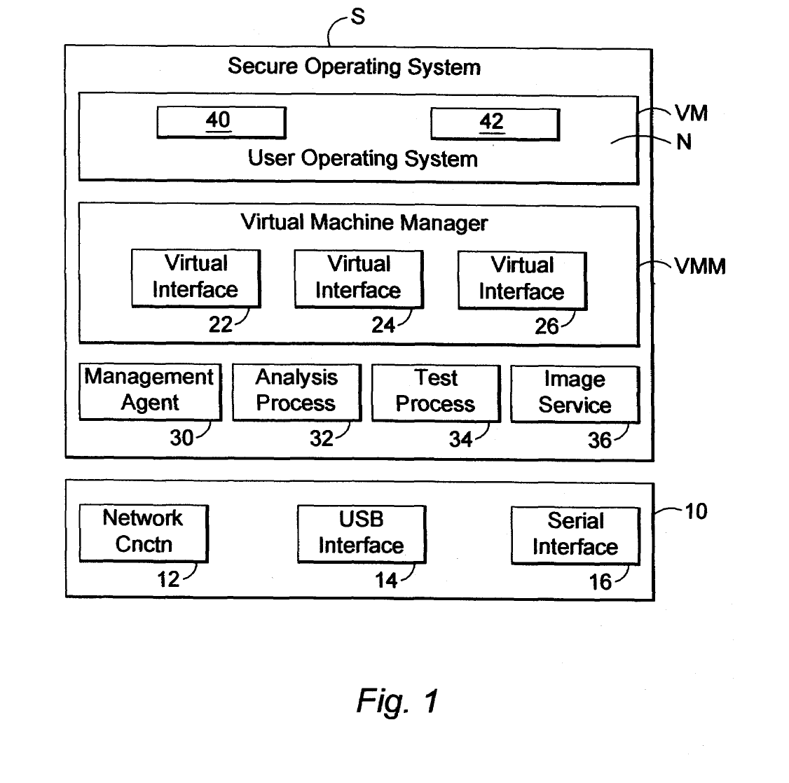

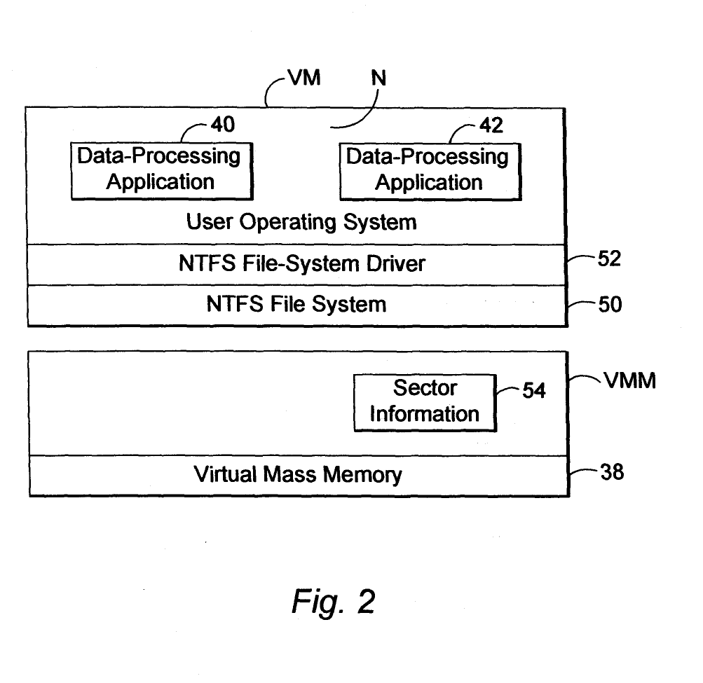

FIG. 1 shows the complete architecture of the computer system for carrying the method according to the invention in an overview. The computer system comprises hardware 10 with a network connection 12, a USB interface 14 and a serial interface 16. A secure operating system S is running on the computer system, which provides a virtual machine VM as a computer program application and virtual interfaces 22, 24, 26 via a virtual machine manager VMM, where a user operating system N, for example, a Windows® operating system is executed on the virtual machine VM. The user operating system N is encapsulated so that the secure operating system S cannot be manipulated from the user operating system N. A management agent 30 for external control of the secure operating system S and various security services is implemented on the secure operating system. The security services comprise an analysis process 32, a test process 34 for detecting harmful files and service 36 for creating images of a virtual mass memory 38 (FIG. 2) of the virtual machine VM.

FIG. 2 shows an embodiment of the method according to the invention where a Windows® operating systems is executed as a user operating system N on the virtual machine VM. As usual, various data-processing applications 40 and 42 can be executed by a user in the user operating system N. Read accesses of the user operating system N to an NTFS file system 50 take place via its Windows® kernel with its NTFS file system driver 52. These read accesses are intercepted by the virtual machine manager VMM and transferred to the analysis process 32 that assigns the data blocks requested within the scope of the read access to a file using sector information 54 of the user operating system N and identifies all the data blocks pertaining to the file. The analysis process 32 controls a test process 34 (scan engine) for detecting harmful files where an examination of the requested file can be triggered according to the requirements. If the requested file is virus-free, the virtual machine manager VMM enables an access to the virtual mass memory 38.

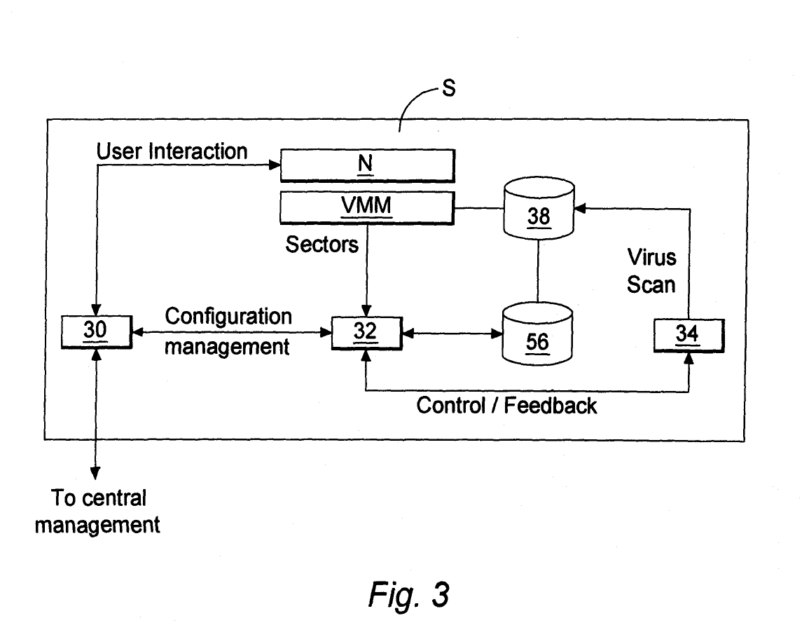

FIG. 3 shows the read access control architecture. Read accesses of the user operating system N executed on the virtual machine VM are intercepted by the virtual machine manager VMM and transferred to the analysis process 32. Using a data structure 56 that links the data blocks of the virtual mass-memory 38 with the files located therein, and that links the files with state variables, it is determined whether the requested file is to be examined by the test process 34 (scan engine). In the data structure 56 the state value “clean” or “dirty” is kept for each of the files. A file that is assigned the value “clean” is not examined by the test process 34, and the analysis process 32 grants a read access via the virtual machine manager VMM. If the file carries the state value “dirty,” it is examined by the test process 34 (scan engine). If the file is undamaged, the allocated state value is set to “clean” and a read access is granted. If the examined file has been manipulated by malware, this will be overwritten, and the analysis process 32 refuses the read access of the user operating system N.

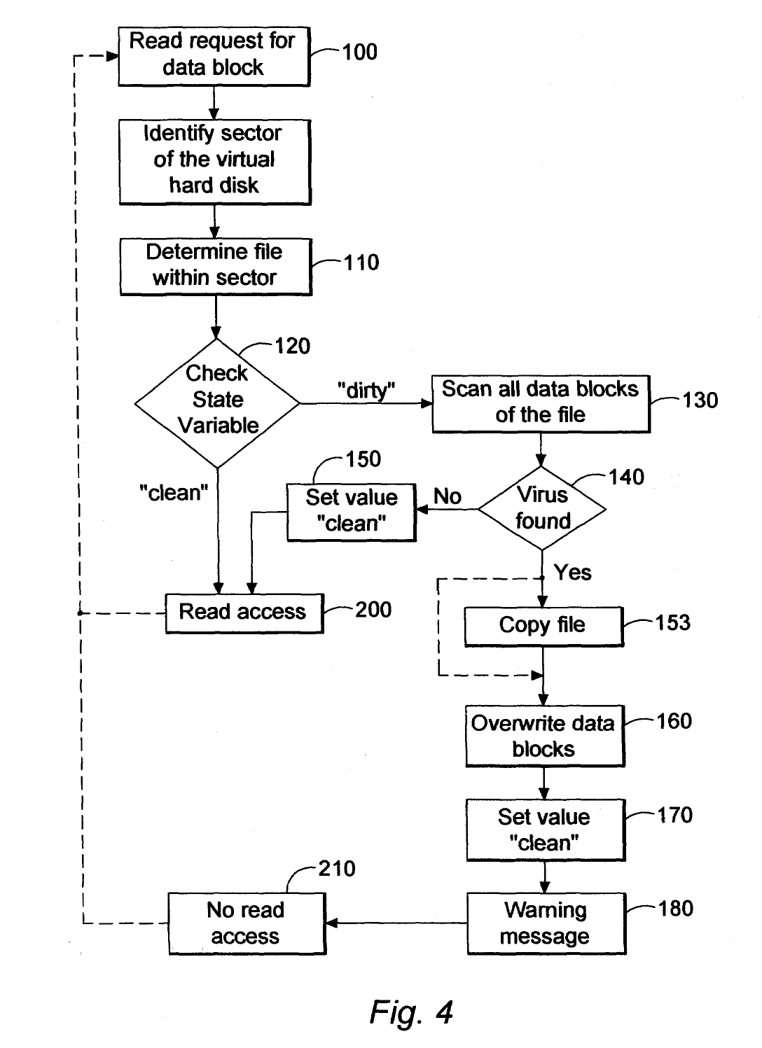

FIG. 4 is a block diagram showing the sequence of the method according to the invention during monitoring of the read access of the user operating system N. A read request 100 of the user operating system N to a data block in the virtual mass memory is intercepted and the file pertaining to the data block and all further data blocks pertaining to the file are determined at 110. The state value assigned to the file is then checked at 120. If the file is assigned the state value “clean,” a read access 200 is granted and the next request 100 of the user operating system N for a read access is processed. If the state value of the file is “dirty,” the scan engine scans all the file blocks of the file 130. If no virus is found 140, the state value of the file is set at 150 to “clean” and a read access is subsequently granted at 200. If it is established that the file is harmful, the assigned data blocks are overwritten, where a copying 153 of the file in a first memory area of the secure operating system can optionally be provided previously. After overwriting at 160 of the data blocks of the file, the allocated state value is set at 170 to “clean” and a warning message is issued to the user or an administrator at 180. Finally, the read access is finally refused 210 before the next request 100 of the user operating system N for a read access is processed.

We claim:

1. A method of secure data processing on a computer system with a higher-level or coordinated secure operating system that is not visible for a user, wherein
the secure operating system as a computer program application provides a virtual machine (VM) with virtual computer hardware on which a user operating system visible to and usable by the user can be executed and which has at least one virtual mass memory with a file system of the user operating system, or
the secure operating system is encapsulated in a first virtual machine and the user operating system visible to and usable by the user and equipped with at least one virtual mass memory with a file system is executed in a second virtual machine,
the secure operating system cannot by manipulated by the user or a computer program application, in particular malware,
the file system of the user operating system is read in and provided to an analysis process executed on the secure operating system,
a read access of the user operating system to a data block in the virtual mass memory (sector) is intercepted and transferred to the analysis process that assigns the data block to a file and determines all the data blocks pertaining to the file, and
the analysis process controls a test process executed in the secure operating system (scan engine) to detect harmful files.

2. The method defined in claim 1, further comprising the step of
creating a data structure that links the sectors of the virtual mass memory with the files located therein and that links each file with a state variable.

3. The method defined in claim 2, further comprising the step of
providing files in the virtual mass memory that have been checked by the test process to detect harmful files and have been identified as harmless with a first state variable (“clean”) and files that have not yet been checked or that have been modified by the user operating system are provided with a second state variable (“dirty”).

4. The method defined in claim 1, further comprising the step of
copying a file identified by the test process as a harmful file into a secured memory area of the secure operating system.

5. The method defined in claim 1, further comprising the step of
overwriting a file that is identified by the test process as a harmful file and thus making it unusable such that a read access of the user operating system to this file is denied.

6. The method defined in claim 1, further comprising the step of
creating with the secure operating system an image (memory image) of the virtual hard disk.

7. The method defined in claim 6, further comprising the step of
checking the virtual hard disk by the test process in the non-active state of the user operating system.

8. The method defined in claim 6, further comprising the step of
checking the image of the virtual hard disk by the test process during operation of the user operating system.

9. The method defined in claim 7, further comprising the step of
replacing a harmful file of the virtual hard disk or of the image of the virtual hard disk with a corresponding undamaged file.

10. The method defined in claim 7, further comprising the step of first making unusable and thereafter replacing manually with a corresponding undamaged file a harmful file of the virtual hard disk or of the image of the virtual hard disk.
